(19) United States
(12) Patent Application Publication
(10) Pub. No.: US 2025/0268242 A1
(43) Pub. Date: Aug. 28, 2025

(54) SYSTEM AND METHOD FOR AN AGRICULTURAL APPLICATOR

(71) Applicant: CNH Industrial America LLC, New Holland, PA (US)

(72) Inventors: Roy A. Bittner, Reedsville, WI (US); Blaine Schwalbe, Valders, WI (US)

(21) Appl. No.: 18/587,201

(22) Filed: Feb. 26, 2024

(51) Int. Cl. A01M 7/00

(52) U.S. Cl. CPC A01M 7/0057; A01M 7/0042

(57) ABSTRACT

A system for a boom assembly may include a retainer operably coupled with a mast frame. The retainer may define a channel extending along a rotational axis. An axle may be positioned at least partially within the retainer and may extend rearward of the base plate, the axle extending along the rotational axis. A boom assembly may include a center section configured to support one or more boom arms. The center section may include a base plate operably coupled with the center section. A bearing assembly may include a hub operably coupled with the base plate and a race assembly operably coupled with the axle. The bearing assembly may be configured to guide the rotation of the center section relative to the mast about the rotational axis.

### FIELD

The present disclosure generally relates to agricultural implements and, more particularly, to systems and methods for a boom system.

### BACKGROUND

Various types of vehicles utilize applicators (e.g., vehicles, floaters, etc.) to deliver an agricultural product to a ground of a field. The agricultural product may be in the form of a solution or mixture, with a carrier (such as water) being mixed with one or more active ingredients (such as an herbicide, fertilizer, fungicide, a pesticide, or another product).

The applicators may be pulled as an implement or self-propelled and can include a tank, a pump, a boom assembly, and a plurality of nozzles carried by the boom assembly at spaced locations. The boom assembly can include a pair of boom arms, with each boom arm extending to either side of the applicator when in an unfolded state. Each boom arm may include multiple boom sections, each with a number of spray nozzles (also sometimes referred to as spray tips).

During a spray operation, the vehicle drives over a target to direct the agricultural product at the target. However, the various factors may cause the boom arm to move thereby placing various sections of the boom arms at heights that are varied from a defined height above the target. Accordingly, a vehicle that is capable of altering a position of the boom assembly would be welcomed in the technology.

### BRIEF DESCRIPTION

Aspects and advantages of the technology will be set forth in part in the following description, or may be obvious from the description, or may be learned through practice of the technology.

In some aspects, the present subject matter is directed to a system for a boom assembly. The system includes a retainer operably coupled with a mast frame of a mast. The retainer defines a channel extending along a rotational axis. An axle is positioned at least partially within the retainer, the axle extending along the rotational axis. A boom assembly includes a center section configured to support one or more boom arms. The center section includes a base plate operably coupled with the center section, the base plate defining a void and a bearing assembly including a hub operably coupled with the base plate and a race assembly operably coupled with the axle. The bearing assembly is configured to guide rotation of the center section relative to the mast about the rotational axis.

In some aspects, the present subject matter is directed to a method of manufacturing a boom system. The method includes operably coupling a bearing assembly with a boom assembly and an axle. The bearing assembly is configured to rotate about a rotational axis and rotatable about a rotational axis. The method also includes positioning the axle within a retainer coupled with a mast, the axle extending along the rotational axis.

In some aspects, the present subject matter is directed to a system for a boom assembly that includes a retainer defining a channel extending along a rotational axis. An axle is positioned at least partially within the retainer and extends along the rotational axis. A bearing assembly is operably coupled with the axle. The bearing assembly is configured to guide rotation of a center section of a boom assembly relative to a mast about the rotational axis.

These and other features, aspects, and advantages of the present technology will become better understood with reference to the following description and appended claims. The accompanying drawings, which are incorporated in and constitute a part of this specification, illustrate examples of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a front perspective view of a machine in accordance with aspects of the present subject matter;

FIG. 2 illustrates a rear perspective view of the machine in accordance with aspects of the present subject matter;

FIG. 3 illustrates a side view of the machine in accordance with aspects of the present subject matter;

FIG. 4 illustrates a rear view of the machine in accordance with aspects of the present subject matter;

FIG. 5 illustrates a partial rear view of a boom system in accordance with aspects of the present subject matter;

FIG. 6 illustrates a partial bottom view of a boom system in accordance with aspects of the present subject matter;

FIG. 7 illustrates a partial side view of a boom system in accordance with aspects of the present subject matter;

FIG. 8 illustrates a cross-sectional view taken along the line VIII-VIII of FIG. 5;

FIG. 9 illustrates a perspective enhanced view of section IX of FIG. 8;

FIG. 10 illustrates a side enhanced view of section X of FIG. 8;

FIG. 11 is a schematic view of an agricultural system in accordance with aspects of the present subject matter; and

FIG. 12 illustrates a flow diagram of a method of manufacturing a boom system in accordance with aspects of the present subject matter.

Repeat use of reference characters in the present specification and drawings is intended to represent the same or analogous features or elements of the present technology.

### DETAILED DESCRIPTION

Reference now will be made in detail to embodiments or examples of the disclosure, one or more examples of which are illustrated in the drawings. Each example is provided by way of explanation of the discourse, not limitation of the disclosure. In fact, it will be apparent to those skilled in the art that various modifications and variations can be made in the present disclosure without departing from the scope or spirit of the disclosure. For instance, features illustrated or described as part can be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the defined functionality is achieved, irrespective of architectures or intermedial components. Likewise, any two components so associated can also be viewed as being “operably connected” or “operably coupled” to each other to achieve the defined functionality, and any two components capable of being so associated can also be viewed as being “operably couplable” to each other to achieve the defined functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to a system for a boom assembly that may include a retainer operably coupled with a mast frame. The retainer may define a channel extending along a rotational axis. An axle may be positioned at least partially within the retainer and may extend rearward of the base plate, the axle extending along the rotational axis. A boom assembly may include a center section configured to support one or more boom arms. The center section may include a base plate operably coupled with the center section. A bearing assembly may include a hub operably coupled with the base plate and a race assembly operably coupled with the axle. The bearing assembly may be configured to guide the rotation of the center section relative to the mast about the rotational axis. The bearing assembly may allow for the decoupling of the boom assembly from at least a portion of the rolling action of a chassis operably coupled with the boom assembly.

Traditionally, the rotational axis is above the range of center of gravity positions to generate a pendulum effect. This allows gravity to be a factor in locating the position to which the center section of the boom assembly to rotate relative to a mast and/or the chassis. As such, the system for a boom assembly described herein may remove or reduce gravity's influence on a roll angle, and use the inherent inertia of the boom combined with electronics that may be hydraulicly powered to influence the roll angle. Accordingly, the location of the rotational axis may be lower than in traditional boom assemblies and/or close enough to a center of gravity to minimize gravity's effect. In various instances, the rotational axis may be proximate to and/or aligned with a center of gravity of the boom assembly. Additionally, in some cases, the rotational axis may be below a center of gravity of the boom assembly. The system for a boom assembly described herein can allow for increased control, e.g., closed-loop control, of the boom assembly to determine a position of the boom assembly as the boom assembly does not have to work against gravity to the same extent as when the rotational axis is offset from the center of gravity of the boom assembly. As used herein, the rotational axis may be a point about which the center section of the boom assembly may rotate and the center of gravity may be a point at any given time where the weighted relative position of the distributed weight of the boom assembly and/or the center section and any boom arms of the boom assembly sums to zero. As such, the center of gravity may be the point to which a weight of the boom assembly is evenly distributed in all directions.

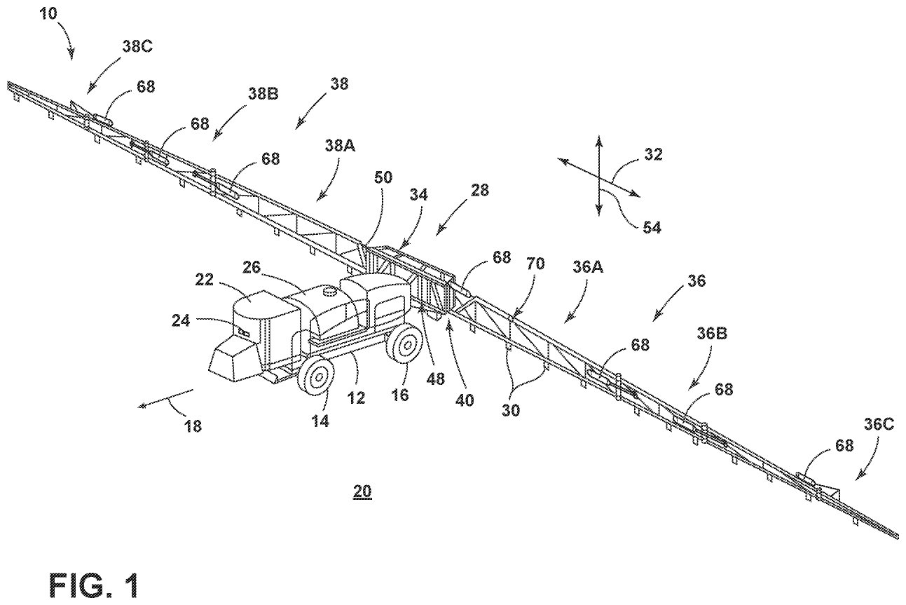

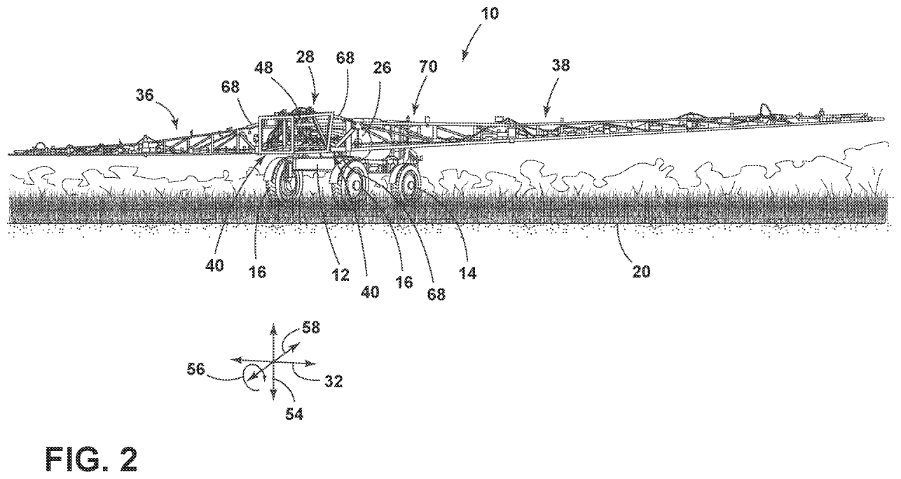

Referring now to FIGS. 1-4, differing views of a machine 10 are illustrated in accordance with aspects of the present subject matter. In the illustrated examples, the machine 10 is configured as a self-propelled vehicle. However, in alternative examples, the machine 10 may be configured as any other suitable type of vehicle configured to perform agricultural spraying operations, such as a tractor or other vehicle configured to haul a spraying or application implement.

As shown in FIGS. 1-4, the machine 10 may include a chassis 12 or frame configured to support or couple to a plurality of components. For example, front wheels 14 and rear wheels 16 may be coupled to the chassis 12. The wheels 14, 16 may be configured to support the machine 10 relative to the ground 20 and move the machine 10 in a direction of travel (e.g., as indicated by arrow 18 in FIG. 1) across the ground 20.

The chassis 12 may also support an operator's cab 22 that houses various control or input devices (e.g., levers, pedals, control panels, buttons, and/or the like) for permitting an operator to control the operation of the machine 10. For instance, as shown in FIG. 1, the machine 10 may include a human-machine or user interface 24 for displaying message windows and/or alerts to the operator and/or for allowing the operator to interface with the vehicle's controller or computing system.

Furthermore, the chassis 12 may also support one or more tanks 26, which may be in the form of a product tank and/or an auxiliary tank. Each product tank is generally configured to store or hold an agricultural product, such as a pesticide, an herbicide, a nutrient, and/or the like. The auxiliary tank may be configured to store or hold clean water and/or any other product, which may be different from the agricultural product within the product tank.

The chassis 12 may further support a boom assembly 28 operably mounted to the chassis 12. A plurality of nozzle assemblies 30 are mounted on the boom assembly 28 and configured to selectively dispense the agricultural product stored in the one or more tanks 26 via the nozzle assemblies 30 onto underlying plants and/or soil. The nozzle assemblies 30 are generally spaced apart from each other on the boom assembly 28 along a lateral direction 32. Furthermore, fluid conduits may fluidly couple the nozzle assemblies 30 to the tank(s) 26. Each nozzle assembly 30 may include a nozzle valve and an associated spray tip or spray nozzle. In several instances, the operation of each nozzle valve may be individually controlled by an associated controller or computing system such that the valve regulates the flow rate and/or another spray characteristic of the agricultural product through the associated spray nozzle.

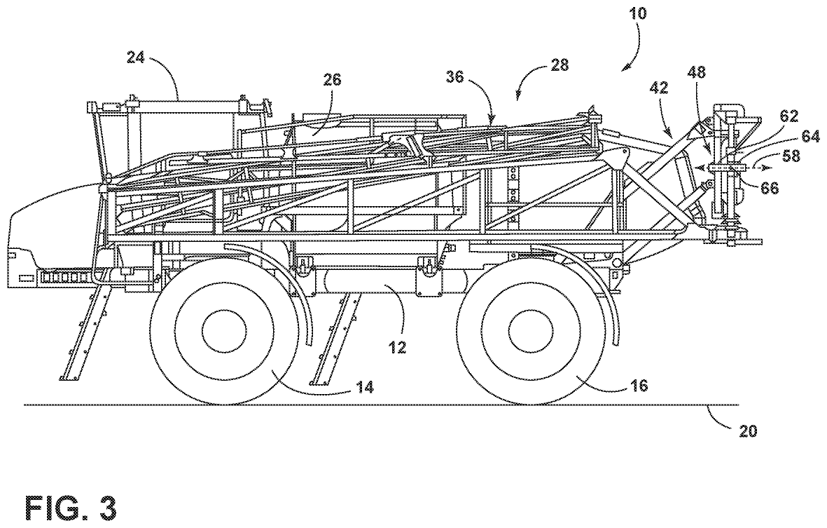

As shown in FIGS. 1-4, in various examples, the boom assembly 28 may include a center section 34, a first boom arm 36, and a second boom arm 38. The first boom arm 36 may include a first inner boom section 36A pivotably coupled to the center section 34, a first middle boom section 36B pivotably coupled to the first inner boom section 36A, and a first outer boom section 36C pivotably coupled to the first middle boom section 36B. Similarly, the second boom arm 38 may include a second inner boom section 38A pivotably coupled to the center section 34, a second middle boom section 38B pivotably coupled to the second inner boom section 38A, and a second outer boom section 38C pivotably coupled to the second middle boom section 38B. Each of the inner boom sections 36A, 38A is pivotably coupled to the center section 34 at pivot joints 40. For example, the pivotable movement of the boom sections relative to one another may allow the various boom sections to move between a fully extended or working position (e.g., as shown in FIGS. 1,2, and 4), in which the boom sections are unfolded along the lateral direction 32 to allow for the performance of an agricultural spraying operation, and a transport position (FIG. 3), in which the boom sections are folded inwardly to reduce the overall width of the boom assembly 28 along the lateral direction 32. Although the boom assembly 28 is shown in FIGS. 1-4 as including a center section 34 and three individual boom sections coupled to each side of the center section 34, the boom assembly 28 may generally have any suitable number of boom sections. For example, in other examples, each boom arm 36, 38 may include four or more boom sections or less than three boom sections.

In various examples, the boom assembly 28 can also include a support system 42 that may extend between the chassis 12 of the machine 10 and the mast 48 to support the mast 48, and to facilitate height adjustment of the mast 48 relative to the ground 20. In this manner, the height of the boom assembly 28 relative to the ground 20 may be adjusted to accommodate various crops, soil conditions, and/or delivered products, for example. In some cases, the weight of the first boom arm 32 and/or the second boom arm 34 may be supported by the center section 34, and the center section 34 may transfer the load to the mast 48 via a linkage assembly 50 and/or a rotational assembly 52. The mast 48, in turn, transfers the load to the machine chassis 12 via the support system 42, thereby suspending the boom assembly 28 above the ground 20. In some cases, the support system 42 can include one or more links 44 and/or one or more support actuators 46. In some instances, the one or more links 44 may be pivotably coupled, or otherwise operably coupled, with the chassis 12 and/or the mast 48. Similarly, the one or more actuators 46 may be pivotably coupled, or otherwise operably coupled, with the chassis 12 and/or the mast 48.

In some examples, the boom assembly 28 may include a mast 48 coupled to the center section 34. The mast 48 can support the boom assembly 28 relative to the machine chassis 12. For example, the center section 34 can be coupled to the mast 48 via a linkage assembly 50 and/or a rotational assembly 52, that, in combination or individually, may be configured to transfer a downward load (e.g., as indicated by line 54) of the center section 34 to the mast 48. For instance, the weight of the first boom arm 36 and/or the second boom arm 38 may be supported by the center section 34, and the center section 34 transfers the load to the mast 48 via the linkage assembly 50 and/or the rotational assembly 52. The mast 48, in turn, transfers the load to the machine chassis 12, thereby suspending the boom assembly 28 above the ground 20. Furthermore, the center section 34 may experience rotation (e.g., as indicated by line 56) of the center section 34 relative to the mast 48 about a rotational axis 58, which may be parallel to the direction of travel 18. For example, if the machine 10 tilts to one side due to variations in the terrain, the center section 34, the first boom arm 32 and/or the second boom arm 34 may rotate about the rotational axis 58, illustrated by rotational line 56.

In various examples, the linkage assembly 50 can include one or more position actuators 60 that may be configured to rotate the center section 34 relative to the mast 48 about the rotational axis 58. Additionally or alternatively, the one or more position actuators 60 may be configured to adjust the height of the boom assembly 28 relative to the mast 48.

In various instances, the rotational assembly 52 can include a retainer 72 operably coupled with a first component of the boom assembly 28 (such as the mast 48), a bearing assembly 64 operably coupled with a second component of the boom assembly 28 (such as the center section 34), and an axle 62 operably coupled with the retainer 72 and the bearing assembly 64. The bearing assembly 64 may rotate about the rotational axis 58.

In various instances, the location of the rotational axis 58 may be lower than in traditional boom assemblies and/or close enough to a center of gravity 66 to minimize and/or reduce gravity's effect. In various instances, the rotational axis 58 may be proximate to and/or aligned with the center of gravity 66 of the boom assembly. Additionally, in some cases, the rotational axis 58 may be below a center of gravity 66 of the boom assembly 28. The system for a boom assembly 28 described herein can allow for increased control, e.g., closed-loop control, of the boom assembly 28 to determine a position of the boom assembly 28 as the boom assembly 28 does not have to work against gravity to the same extent as when the rotational axis is offset from the center of gravity of the boom assembly.

Additionally, as shown in FIGS. 1-4, the boom assembly 28 may include any number of boom section actuators 68 that are configured to alter the position of one boom section relative to another, and/or the chassis 12 of the machine 10. In various examples, any of the boom section actuators 68 described herein may be configured as hydraulic cylinders. However, different actuators 68 may be used in other instances. For example, any of the actuators 68 may be configured as electric actuators, pneumatic cylinders, pulley systems, and/or any other practicable device.

With further reference to FIGS. 1-4, the machine 10 may also include a sensor system 70. In general, the sensor system 70 may be configured to capture data indicative of one or more operating conditions or parameters associated with the performance and/or operation of the machine 10, a system operably coupled with the machine 10, an assembly operably coupled with the machine 10, such as the boom assembly 28. For example, the sensor system 70 may be configured to generate data indicative of a position of the boom assembly 28 relative to a chassis 12. The sensor system 70 may include one or more sensors 88, a weather station, and/or any other assembly, which may be installed on the machine 10 and/or the boom assembly 28. For instance, in some examples, the one or more sensors 88 may be installed on the boom assembly 28 to allow operating parameters/conditions associated with the boom assembly 28 to be monitored. However, one or more sensors 88 may be installed relative to or in association with any other suitable components, features, systems, and/or sub-systems of the machine 10. In various examples, the sensors 88 may include position sensors, flow sensors, motion sensors (e.g., accelerometers, gyroscopes, etc.), image sensors (e.g., cameras, LIDAR devices, etc.), radar sensors, ultrasonic sensors, and/or the like, depending on the operating conditions being monitored.

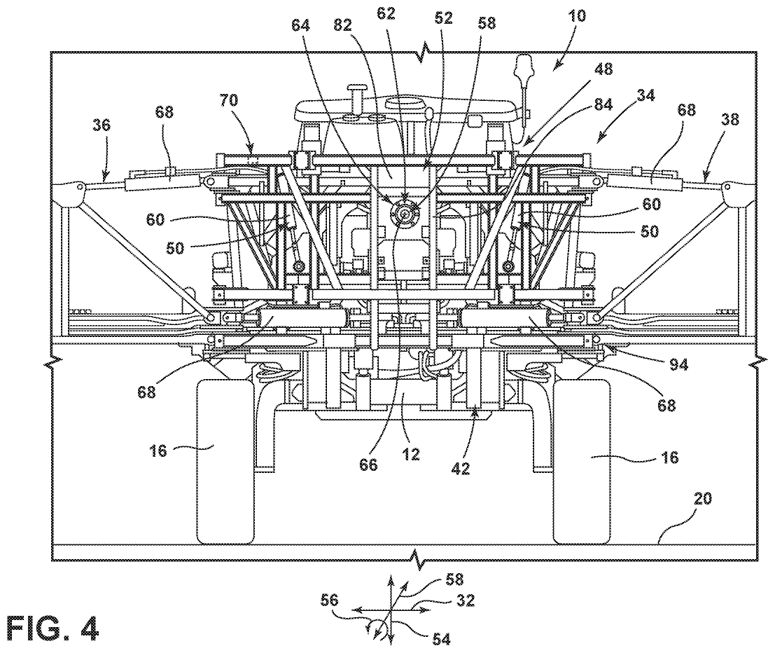

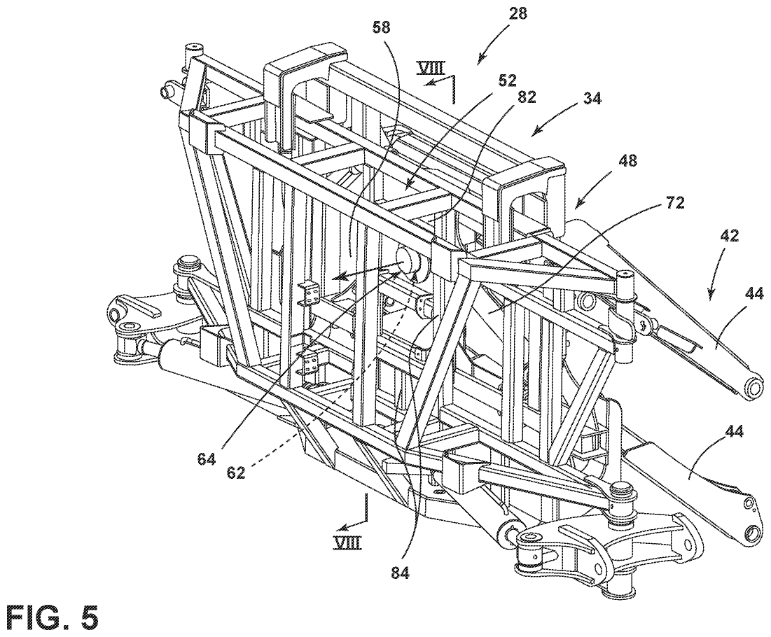

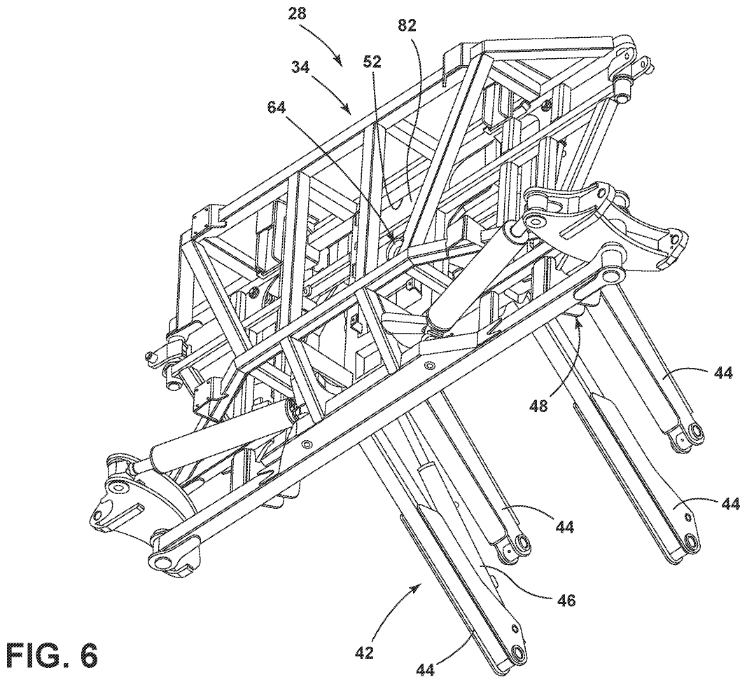

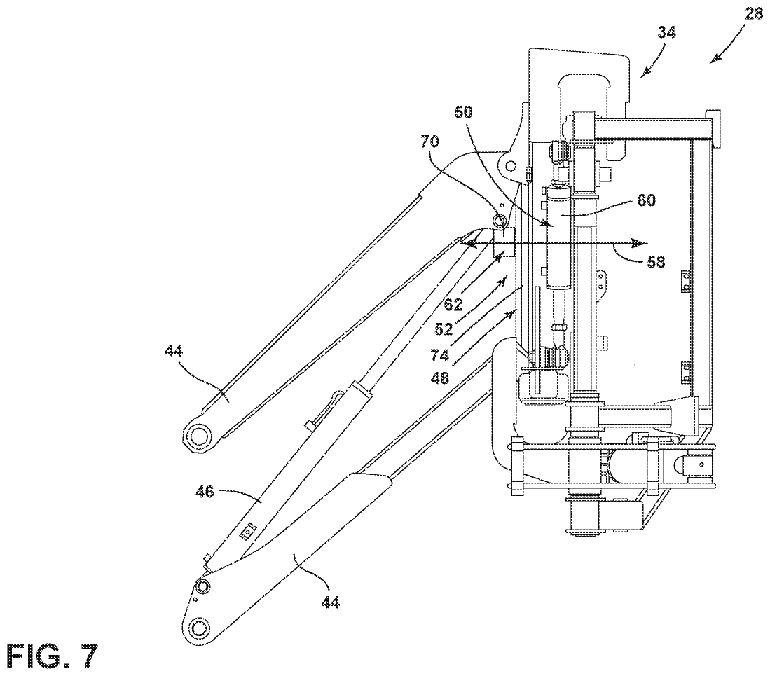

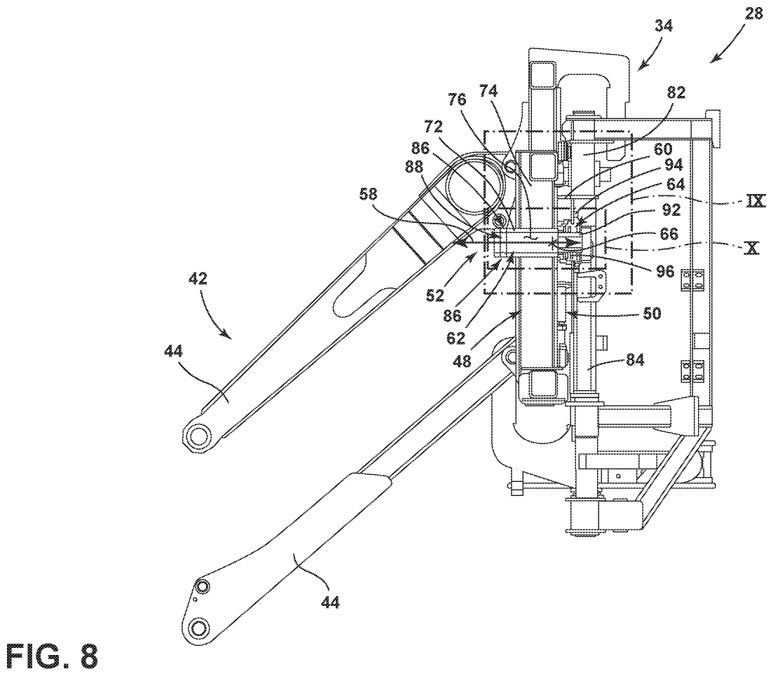

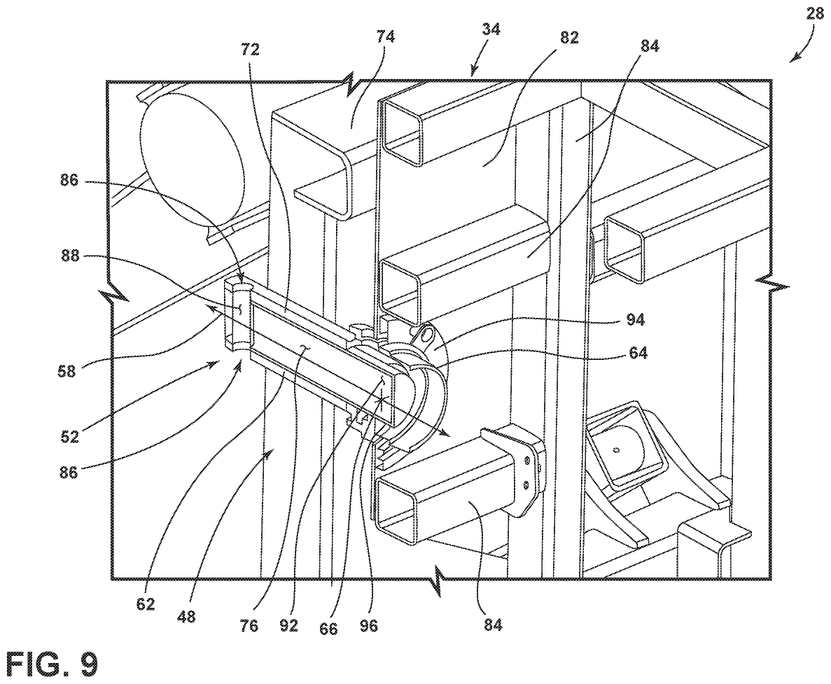

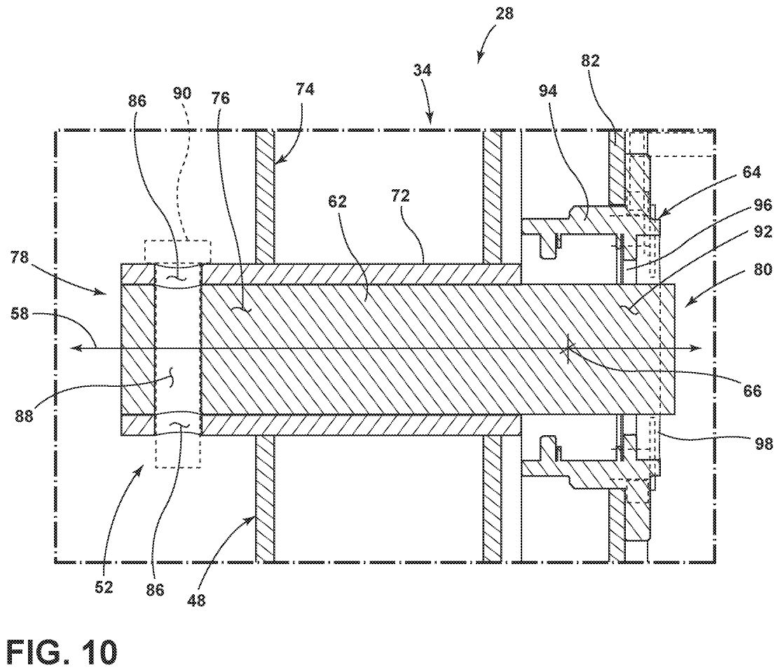

Referring to FIGS. 4-10, the linkage assembly 50 and/or the rotational assembly 52 may facilitate rotation of the center section 34 relative to the mast 48 in a direction 56 (i.e., about a rotational axis 58 parallel to the direction of travel 18). For instance, a center of gravity 66 of the boom assembly 28 may be defined within the center section 34 of the boom assembly 28. The rotational assembly 52 may define a rotational axis 58 in a direction that is generally parallel to the direction of travel 18 of the machine 10. As a result, the boom assembly 28 may generally rotate about rotational axis 58 through the usage of the rotational assembly 52. In some cases, by locating the rotational axis 58 proximate to the center of gravity 66 of the boom assembly 28, increased control, e.g., closed-loop control, of the boom assembly 28 can be achieved as the boom assembly 28 does not have to work against gravity to the same extent as when the rotational axis 58 is offset by greater distances from the center of gravity 66 of the boom assembly 28.

Referring further to FIGS. 4-10, the rotational assembly 52 can include a retainer 72 that is operably coupled with the mast 48 (and/or the center section 34 of the boom assembly 28) and a bearing assembly 64 operably coupled with the center section 34 of the boom assembly 28 (and/or the mast 48). In the illustrated example, the retainer 72 may be operably coupled with a mast frame 74, which may include one or more supports of the mast frame 74. In some instances, the retainer 72 may define a channel 76 that is generally aligned and/or otherwise extends along the rotational axis 58.

An axle 62 may be positioned at least partially within the channel 76 defined by the retainer 72. As such, in some instances, the axle 62 may also extend along the rotational axis 58. As illustrated, a first portion 78 of the axle 62 may extend forward of one or more supports of the mast frame 74 in a fore-aft direction and a second portion 80 of the axle 62 may extend rearward of a base plate 82 in a fore-aft direction that may be operably coupled with one or more base supports 84 and/or any other component of the center section 34.

In some cases, the retainer 72 may define one or more retainment holes 86. In some instances, the one or more retainment holes 86 may be generally perpendicular to an extension direction (e.g., the rotational axis 58) of the channel 76. Similarly, the axle 62 may define a duct 88. In some instances, the duct 88 may be aligned with the retainment holes 86 and a pin 90 may be positioned through the one or more retainment holes 86 and the duct 88 to restrict rotational movement of the axle 62 relative to the retainer 72.

Additionally, the rotational assembly 52 can include a base plate 82 that may be operably coupled with one or more base supports 84 and/or any other component of the center section 34. The base plate 82 may define a void 92 therethrough. In various instances, the void 92 may be offset from a center point of the base plate 82.

In some examples, a bearing assembly 64 can include a hub 94 and a race assembly 96. The hub 94 may be operably coupled with the base plate 82 and the race assembly 96 may be operably coupled with the axle 62. The race assembly 96 may be configured to allow rotational movement of a rotatable portion of the bearing assembly 64 relative to the hub 94. Moreover, the rotatable portion may be fixed or otherwise coupled to the axle 62. As such, once assembled, the center section 34 of the boom assembly 28 may be rotatable relative to the axle 62 and/or the mast 48. In some cases, a cover 98 may be positioned rearward of the race assembly 96 in a fore-aft direction, and/or in any other location. In various other examples, however, the base and the bearing assembly 64 may be otherwise coupled with the mast 48 and the center section 34 in any other manner that allows for rotation of the center section 34 of the boom assembly 28 relative to the mast 48.

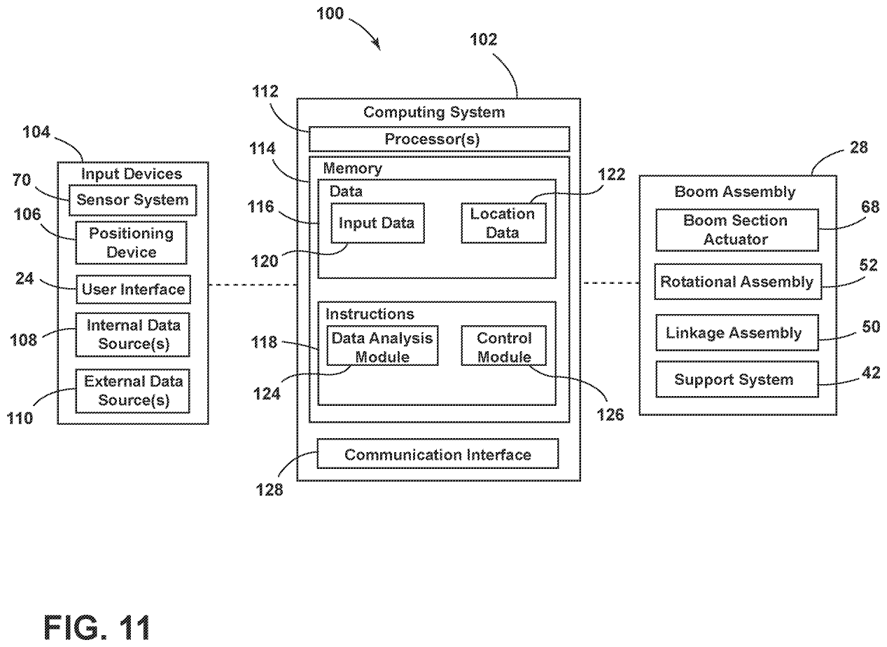

With reference to FIG. 11, a boom system 100 for altering a position of one or more components of the boom assembly 28 will be described with reference to the machine 10 described above with reference to FIGS. 1-10. However, the disclosed system 100 may generally be utilized with agricultural machines having any other suitable machine configuration. In general, when the boom assembly 28 is in the extended position (as illustrated in FIGS. 1 and 3), the position of various sections of the boom assembly 28 may be affected due to the movement of the various sections of the boom assembly 28. In addition, due to the configuration of the boom assembly 28, the actuation of one boom section actuator 68 can impact the manner in which one or more of the other boom section actuators 68 may be controlled to maintain the boom assembly 28 at the defined position relative to the ground 20, which may be based on the ground profile and/or the position profile. As such, the machine 10 may include a system 100 that is configured to determine a position (e.g., a stroke length) for each actuator 68 based on an impact to one or more remaining boom section actuators 68 to maintain the boom assembly 28 at a defined position relative to the ground 20. Moreover, by locating the rotational axis 58 of the rotational assembly 52 proximate to the center of gravity 66 of the boom assembly 28, increased control, e.g., closed-loop control, of the boom assembly 28 can be achieved as the boom assembly 28 does not have to work against gravity to the same extent as when the rotational axis 58 is offset from the center of gravity 66 of the boom assembly 28 by a greater distance.

As shown in FIG. 11, the system 100 can include a computing system 102 operably coupled with various input devices 104 and one or more boom section actuators 68 within the boom assembly 28. In general, the computing system 102 may correspond to any suitable processor-based device(s), such as a computing device or any combination of computing devices. For example, the computing system 102 may generally include one or more processor(s) 112 and associated memory devices 114 configured to perform a variety of computer-implemented functions (e.g., performing the methods, steps, algorithms, calculations, and the like disclosed herein). As used herein, the term “processor” refers not only to integrated circuits referred to in the art as being included in a computer, but also refers to a controller, a microcontroller, a microcomputer, a programmable logic controller (PLC), an application-specific integrated circuit, and other programmable circuits. Additionally, the memory 114 may generally include memory element(s) including, but not limited to, computer-readable medium (e.g., random access memory (RAM)), computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory 114 may generally be configured to store information accessible to the processor(s) 112, including data 116 that can be retrieved, manipulated, created, and/or stored by the processor(s) 112 and instructions 118 that can be executed by the processor(s) 112.

In several examples, the data 116 may be stored in one or more databases. For example, the memory 114 may include an input database 120 for storing input data received from the input device(s). For example, the input device(s) may include the sensor system 70, which may include one or more sensors 88 configured to monitor one or more conditions associated with the machine 10 and/or the operation being performed therewith (e.g., including one or more of the various sensors 88, described above), one or more positioning device(s) 106 for generating position data associated with the location of the machine 10, one or more user interfaces 24 for allowing operator inputs to be provided to the computing system 102 (e.g., buttons, knobs, dials, levers, joysticks, touch screens, and/or the like), one or more other internal data sources 108 associated with the machine 10 (e.g., other devices, databases, etc.), one or more external data sources 110 (e.g., a remote computing device or server), and/or any other suitable input device(s). The data received from the input device(s) may, for example, be stored within the input database 120 for subsequent processing and/or analysis. It will be appreciated that, in addition to being considered an input device(s) that allows an operator to provide inputs to the computing system 102, the user interface 24 may also function as an output device. For example, the user interface 24 may be configured to allow the computing system 102 to provide feedback to the operator (e.g., visual feedback via a display or other presentation device, audio feedback via a speaker or other audio output device, and/or the like).

Moreover, in several examples, the memory 114 may also include a location database 122 storing location information about the machine 10 and/or information about the ground 20 being processed (e.g., a field map). Such location database 122 may, for example, correspond to a separate database or may form part of the input database 120. As shown in FIG. 11, the computing system 102 may be communicatively coupled to the positioning device(s) 106 installed on or within the machine 10. For example, in some examples, the positioning device(s) 106 may be configured to determine the location of the machine 10 using a satellite navigation position system (e.g., a GPS, a Galileo positioning system, the Global Navigation satellite system (GLONASS), the BeiDou Satellite Navigation and Positioning system, and/or the like). In such an example, the location determined by the positioning device(s) 106 may be transmitted to the computing system 102 (e.g., in the form of coordinates) and subsequently stored within the location database 122 for subsequent processing and/or analysis.

Referring still to FIG. 11, in several examples, the instructions 118 stored within the memory 114 of the computing system 102 may be executed by the processor(s) 112 to implement a data analysis module 124. In general, the data analysis module 124 may be configured to analyze the input data (e.g., a set of input data received at a given time or within a given time period or a subset of the data, which may be determined through a pre-processing method) to determine the current one or more operating parameters or conditions of the boom assembly 28 using any algorithm and/or data processing technique. In various examples, the data analysis module 124 may implement machine learning engine methods and algorithms that utilize one or several machine learning techniques including, for example, decision tree learning, including, for example, random forest or conditional inference trees methods, neural networks, support vector machines, clustering, and Bayesian networks. These algorithms can include computer-executable code that can be retrieved by the computing system 102 and may be used to generate subsequent instructions.

In some examples, the data analysis module 124 may receive the input data from one or more input devices 104. In turn, the system 100 may determine a current boom profile based on boom position data and defined boom dimensions/a defined boom geometry. Additionally, the system 100 may determine relative positions at various locations along the boom assembly 28 based on boom height data. In some examples, the system 100 may further calculate a ground profile based on the boom height data. The system 100 may further determine a target boom profile based on the current ground profile. Further, the system 100 may calculate a defined position for one or more boom section actuators 68 of the boom assembly 28 (e.g., a stroke length for each cylinder) to achieve the defined boom profile. In some instances, the defined position for one or more of the boom section actuators 68 of the boom assembly 28 may be based at least partially on an effect of movement of a first actuator of the one or more boom section actuators 68 on a second actuator of the one or more boom section actuators 68 (or the remaining actuators of the one or more actuators) to maintain the boom assembly 28 at the defined position relative to the ground 20.

Referring still to FIG. 11, the instructions 118 stored within the memory 114 of the computing system 102 may also be executed by the processor(s) 112 to implement a control module 126. In general, the control module 126 may be configured to adjust the operation of the machine 10 by controlling one or more components of the machine 10. In several examples, the control module 126 may be configured to control the boom assembly 28 by transmitting respective control commands to actuate each actuator 68 to a defined position to maintain the boom assembly 28 at the defined position relative to the ground 20.

In several examples, the computing system 102 may also automatically control the operation of the user interface 24 to provide an operator notification associated with the determined one or more operating parameters or conditions of the boom assembly 28. For instance, in some examples, the computing system 102 may control the operation of the user interface 24 in a manner that causes data associated with the determined one or more operating parameters or conditions of the boom assembly 28 to be presented to the operator of the machine 10, such as by presenting raw or processed data associated with the one or more operating parameters or conditions of the boom assembly 28 including numerical values, graphs, maps, and/or any other suitable visual indicators.

Moreover, as shown in FIG. 11, the computing system 102 may also include a communications interface 128 to communicate with any of the various other system components described herein. For instance, one or more communicative links or interfaces (e.g., one or more data buses and/or wireless connections) may be provided between the communications interface 128 and the input device(s) to allow data transmitted from the input device(s) to be received by the computing system 102. Additionally, as shown in FIG. 11, one or more communicative links or interfaces (e.g., one or more data buses and/or wireless connections) may be provided between the communications interface 128 and the boom section actuators 68 to allow the computing system 102 to control the operation of such system components.

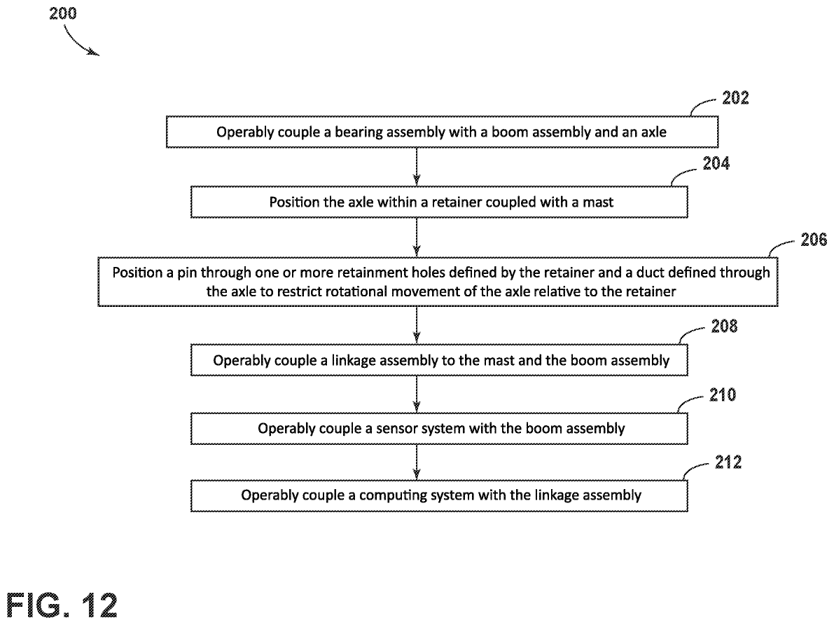

Referring now to FIG. 12, a flow diagram of some examples of a method 200 of manufacturing a boom system for a boom assembly is illustrated in accordance with aspects of the present subject matter. In general, the method 200 will be described herein with reference to the machine 10 and the system 100 described above with reference to FIGS. 1-11. However, the disclosed method 200 may generally be utilized with any suitable machine 10 and/or may be utilized in connection with a system having any other suitable system configuration. In addition, although FIG. 12 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 12, at (202), the method 200 can include operably coupling a bearing assembly with a boom assembly and an axle. The bearing assembly may be configured to rotate about a rotational axis and rotatable about a rotational axis. At (204), the method 200 can include positioning the axle within a retainer coupled with a mast. In some examples, the axle may extend along the rotational axis within a channel defined by the retainer. At (206), the method 200 can include positioning a pin through one or more retainment holes defined by the retainer and a duct defined through the axle to restrict rotational movement of the axle relative to the retainer. At (208), the method 200 can include operably coupling a linkage assembly to the mast and the boom assembly. In some cases, the linkage assembly may be configured to rotate a center section of the boom assembly relative to the mast about the rotational axis.

At (210), the method 200 can include operably coupling a sensor system with the boom assembly. In various examples, the sensor system may be configured to generate data indicative of a position of the boom assembly relative to a chassis. At (212), the method 200 can include operably coupling a computing system with the linkage assembly. In various instances, the computing system may be configured to alter a stroke of one or more actuators of the linkage assembly based on the position of the boom assembly relative to the chassis.

It is to be understood that the steps of any method disclosed herein may be performed by a computing system upon loading and executing software code or instructions that are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions that are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also may include any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for a boom assembly, the system comprising:
a retainer operably coupled with a mast frame of a mast, the retainer defining a channel extending along a rotational axis;
an axle positioned at least partially within the retainer, the axle extending along the rotational axis; and
a boom assembly including a center section configured to support one or more boom arms, the center section comprising:
a base plate operably coupled with the center section, the base plate defining a void; and
a bearing assembly including a hub operably coupled with the base plate and a race assembly operably coupled with the axle, wherein the bearing assembly is configured to guide rotation of the center section relative to the mast about the rotational axis.

2. The system of claim 1, wherein the retainer defines one or more retainment holes that are generally perpendicular to an extension direction of the channel.

3. The system of claim 2, wherein the axle defines a duct, and wherein the duct is aligned with the one or more retainment holes.

4. The system of claim 3, further comprising:
a pin positioned through the one or more retainment holes and the duct to restrict rotational movement of the axle relative to the retainer.

5. The system of claim 1, wherein a first portion of the axle extends forward of one or more supports of the mast frame in a fore-aft direction and a second portion of the axle extends rearward of the base plate in the fore-aft direction.

6. The system of claim 1, further comprising:
a cover positioned rearward of the race assembly in a fore-aft direction.

7. The system of claim 1, wherein the void is offset from a center point of the base plate.

8. The system of claim 1, further comprising:
a linkage assembly configured to rotate the center section relative to the mast about the rotational axis.

9. The system of claim 8, wherein the linkage assembly comprises one or more actuators configured to rotate the center section relative to the mast about the rotational axis.

10. The system of claim 9, further comprising:
a sensor system configured to generate data indicative of a position of the boom assembly relative to a chassis.

11. The system of claim 10, further comprising:
a computing system configured to alter a stroke of the one or more actuators based on the position of the boom assembly relative to the chassis.

12. A method of manufacturing a boom system, the method comprising:
operably coupling a bearing assembly with a boom assembly and an axle, the bearing assembly configured to rotate about a rotational axis and rotatable about a rotational axis; and
positioning the axle within a retainer coupled with a mast, the axle extending along the rotational axis.

13. The method of claim 12, further comprising:
positioning a pin through one or more retainment holes defined by the retainer and a duct defined through the axle to restrict rotational movement of the axle relative to the retainer.

14. The method of claim 12, further comprising:
operably coupling a linkage assembly to the mast and the boom assembly, wherein the linkage assembly is configured to rotate a center section of the boom assembly relative to the mast about the rotational axis.

15. The method of claim 14, further comprising:
operably coupling a sensor system with the boom assembly, the sensor system configured to generate data indicative of a position of the boom assembly relative to a chassis; and
operably coupling a computing system with the linkage assembly, the computing system configured to alter a stroke of one or more actuators of the linkage assembly based on the position of the boom assembly relative to the chassis.

16. A system for a boom assembly, the system comprising:
a retainer defining a channel extending along a rotational axis; and
an axle positioned at least partially within the retainer and extending along the rotational axis;
a bearing assembly operably coupled with the axle, wherein the bearing assembly is configured to guide rotation of a center section of a boom assembly relative to a mast about the rotational axis.

17. The system of claim 16, wherein the retainer is operably coupled with the mast and the bearing assembly is operably coupled with a base plate, the base plate operably coupled with the center section of the boom assembly.

18. The system of claim 16, wherein the bearing assembly includes a hub operably coupled with a base plate and a race assembly operably coupled with the axle, and wherein the bearing assembly is configured to guide rotation of the center section relative to the mast about the rotational axis.

19. The system of claim 16, wherein the retainer defines one or more retainment holes that are generally perpendicular to an extension direction of the channel, wherein the axle defines a duct, and wherein the duct is aligned with the one or more retainment holes.

20. The system of claim 19, further comprising:
a pin positioned through the one or more retainment holes and the duct to restrict rotational movement of the axle relative to the retainer.
